(19) United States
(12) Patent Application Publication
(10) Pub. No.: US 2015/0024226 A1
(43) Pub. Date: Jan. 22, 2015

(54) LAMINATED BODY FOR POLARIZING PLATE, POLARIZING PLATE COMPRISING THE SAME AND LIQUID CRYSTAL DISPLAY DEVICE

(71) Applicant: FUJIFILM Corporation, Tokyo (JP)

(72) Inventor: Yoshinori MAEDA, Kanagawa (JP)

(73) Assignee: FUJIFILM CORPORATION, Tokyo (JP)

(21) Appl. No.: 14/335,090

(22) Filed: Jul. 18, 2014

(30) Foreign Application Priority Data
Jul. 19, 2013 (JP) 2013-150403
Jul. 7, 2014 (JP) 2014-139561
Jul. 17, 2014 (JP) 2014-147038

(51) Int. Cl. B32B 27/08; B32B 27/28; B32B 27/42

(52) U.S. Cl. CPC B32B 27/08; B32B 27/42; B32B 27/286; B32B 2250/02; B32B 2255/26; B32B 2551/00; B32B 2457/202
USPC 428/523; 428/704; 428/532

(57) ABSTRACT

An aspect of the present invention relates to a laminated body, which is a laminated body for a polarizing plate as well as comprises a polymer film and a layer comprising a sulfonyl group-containing compound, wherein either or both of the polymer film and the layer comprising a sulfonyl group-containing compound comprises an aromatic secondary amine.

### CROSS-REFERENCE TO RELATED APPLICATIONS

This application claims priority under 35 U.S.C. 119 to Japanese Patent Application No. 2013-150403 filed on Jul. 19, 2013, Japanese Patent Application No. 2014-139561 filed on Jul. 7, 2014, and Japanese Patent Application No. 2014-147038 filed on Jul. 17, 2014. Each of the above applications is hereby expressly incorporated by reference, in its entirety.

### BACKGROUND OF THE INVENTION

1. Field of the Invention

The present invention relates to a laminated body for a polarizing plate, a polarizing plate that comprises the laminated body and a liquid crystal display device.

2. Discussion of the Background

For polarizing plates used for liquid crystal display devices, a peelable film is commonly pasted so that the surface is not damaged or soiled during conveying or storage. For the peelable film, after a polarizing plate is assembled into a liquid crystal display device, it is normally peeled, however, static build-up may be generated due to peeling, causing display failure such as image disruption and the like, and erroneous operations.

Moreover, dust attached to the polarizing plate by static build-up during production, storage, conveying and the like may cause display failure of the liquid crystal display device with a polarizing plate assembled therein.

From the standpoint described above, a polarizing plate assembled into a liquid crystal display device is required to have high antistatic performance. Regarding the above point, For example in published Japanese translation of PCT international publication for patent application (TOKUHYO) No. 2009-504874 or English language family member US2007/191517A1 and published Japanese translation of PCT international publication for patent application (TOKUHYO) No. 2010-525098 or English language family member US2010/188620A1, which are expressly incorporated herein by reference in their entirety, it is proposed to add an antistatic agent to the adhesive layer for pasting a polarizing plate and a liquid crystal cell. In addition, in Japanese Unexamined Patent Publication (KOKAI) No. 2009-86244, it is proposed to form an antistatic layer from a conductive polymer.

### SUMMARY OF THE INVENTION

However, according to the study by the inventor, regarding a liquid crystal display device with layers that contain an antistatic agent and a conductive polymer, it was revealed that in polymer films such as protective films, phase difference films, supporter films and the like of phase difference films, transmissivity reduction may be generated by haze that causes a reduction in the display performance of the liquid crystal display device.

An aspect of the present invention provides for a laminated body for a polarizing plate that comprises polymer film with high transmissivity, along with antistatic performance.

The inventor conducted extensive research, and as a result, found an aspect of the present invention, that is, a laminated body, which is a laminated body for a polarizing plate as well as comprises a polymer film and a layer comprising a sulfonyl group-containing compound, wherein either or both of the polymer film and the layer comprising a sulfonyl group-containing compound comprises an aromatic secondary amine.

This point will be further described below. However, the following has been presumed by the present inventor and does not limit the present invention in any way.

In the above published Japanese translation of PCT international publication for patent application (TOKUHYO) Nos. 2009-504874 and 2010-525098, using sulfonyl group-containing compound as an antistatic agent is disclosed. In addition, in the above Japanese Unexamined Patent Publication (KOKAI) No. 2009-86244, a complex of polythiophene polymer and polyanion is disclosed as a conductive polymer. Furthermore, as polyanion, a homopolymer or a copolymer of styrene sulfonic acid such as polystyrene sulfonic acid and the like is disclosed. In the polymer of styrene sulfonic acid, a sulfonyl group is included.

However, a sulfonyl group-containing compound generates a very small amount of strong acid over time due to heat and/or humidity. It is thought that the strong acid thus generated may change the property of polymer film (hydrolysis), thus causing the aforementioned haze generation (transmissivity reduction).

On the other hand, the inventor attempted to neutralize a strong acid using basic compounds to solve the aforementioned phenomenon, then it was possible to prevent property change of polymer film, but it was found out that sometimes the polarizer changed its property. Property change of a polarizer may deteriorate polarizing performance so this should be avoided.

Hence, the inventor made further studies, as a result, it was found that as the basic compound that neutralizes a strong acid, aromatic secondary amine was used, thereby both of transmissivity reduction of polymer films and static build-up in polarizing plates could be prevented and furthermore, property change of polarizer was able to be inhibited. The inventor infers that aromatic secondary amine is able to prevent property change of polymer film by strong acid derived from sulfonyl group-containing compound that functions as antistatic agent.

The laminated body for polarizing plate described above was completed based on the above finding.

In an embodiment, the aromatic secondary amine comprises a heteroaromatic ring.

In an embodiment, the sulfonyl group-containing compound is a metal salt of sulfonyl imide anion and metal cation.

In an embodiment, the sulfonyl group-containing compound is a metal salt of fluorosulfonylimide anion and metal cation.

In an embodiment, sulfonyl group-containing compound is a metal salt of sulfonyl imide anion and alkaline metal cation.

In an embodiment, the sulfonyl group-containing compound is a compound that comprises a sulfonyl group in the form of a sulfo group or a salt thereof.

In an embodiment, the sulfonyl group-containing compound is a polymer of styrene sulfonic acid or a salt thereof.

In an embodiment, the layer that comprises the sulfonyl group-containing compound is an adhesive layer or an intermediate layer positioned between an adhesive layer and the polymer film.

In an embodiment, the adhesive layer comprises acrylic adhesive.

In an embodiment, the polymer film is a cellulose acylate film.

In an embodiment, the laminated body for the polarizing plate comprises the layer that comprises the sulfonyl group-containing compound as the layer that directly contacts the polymer film.

A further aspect of the present invention relates to a polarizing plate that comprises the laminated body for a polarizing plate described above and a polarizer.

A further aspect of the present invention relates to a liquid crystal display device that comprises the polarizing plate described above and a liquid crystal cell.

An aspect of the present invention can provide a polarizing plate which has high transmissivity even after a long time under high temperature and high humidity as well as wherein generation of peeling static build-up can be inhibited during film peeling of polarizing plate protective film. By using such a polarizing plate, a liquid crystal display device which has high reliability and is superior in display performance can be provided.

Other exemplary embodiments and advantages of the present invention may be ascertained by reviewing the present disclosure and the accompanying drawings.

### BRIEF DESCRIPTION OF THE DRAWINGS

The present invention will be described in the following text by the exemplary, non-limiting embodiments shown in the figure, wherein:

FIG. 1 is a schematic cross section drawing showing a layer configuration of a polarizing plate in an embodiment according to an aspect of the present invention.

FIG. 2 is a schematic cross section drawing showing a layer configuration of a polarizing plate in another embodiment according to an aspect of the present invention.

### DETAILED DESCRIPTION OF THE EMBODIMENTS

Unless otherwise stated, a reference to a compound or component includes the compound or component by itself, as well as in combination with other compounds or components, such as mixtures of compounds.

As used herein, the singular forms “a,” “an,” and “the” include the plural reference unless the context clearly dictates otherwise.

Except where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not to be considered as an attempt to limit the application of the doctrine of equivalents to the scope of the claims, each numerical parameter should be construed in light of the number of significant digits and ordinary rounding conventions.

Additionally, the recitation of numerical ranges within this specification is considered to be a disclosure of all numerical values and ranges within that range. For example, if a range is from about 1 to about 50, it is deemed to include, for example, 1, 7, 34, 46.1, 23.7, or any other value or range within the range.

The following preferred specific embodiments are, therefore, to be construed as merely illustrative, and non-limiting to the remainder of the disclosure in any way whatsoever. In this regard, no attempt is made to show structural details of the present invention in more detail than is necessary for fundamental understanding of the present invention; the description taken with the drawings making apparent to those skilled in the art how several forms of the present invention may be embodied in practice.

### Laminated Body for Polarizing Plate

An aspect of the present invention relates to a laminated body for a polarizing plate wherein the laminated body comprises a polymer film and layer comprising a sulfonyl group-containing compound as well as an aromatic secondary amine is contained in either or both of the polymer film and the layer comprising a sulfonyl group-containing compound.

The above laminated body for a polarizing plate (also referred to simply as a “laminated body”, hereinafter) will be further described below. In the present invention, if a certain group has one or more substituent, examples of the substituent include: an alkyl group (for example, an alkyl group with the carbon number of 1 to 6), a hydroxyl group, an alkoxy group (for example, alkoxy group with the carbon number of 1 to 6), halogen atoms (for example, fluorine atom, chlorine atom, bromine atom), a cyano group, an amino group, a nitro group, an acyl group, a carboxyl group, and the like. As to the group with one or more substituent, the carbon number means the carbon number of the part without a substituent. Moreover, “to” in the present invention shows the range that contains minimum and maximum values of the numeric value described before and after that.

Sulfonyl Group-Containing Compound

The sulfonyl group-containing compound is a compound that contains at least one sulfonyl group (—SO₂—), and can function as an antistatic agent. The sulfonyl group can be contained as sulfonyl imide anion [(—SO₂—N—SO₂—)⁻]. In addition, examples of the sulfonyl group-containing compound include a compound that contains a sulfonyl group in the form of sulfo group (—SO₃H) or its salt form, such as a polymer of styrene sulfonic acid as set forth above.

An example of sulfonyl imide anion is sulfonyl imide anion represented by the following (1).

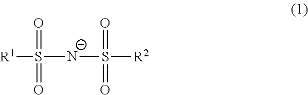

In the formula (I), R¹ and R² independently represent a substituent. As a substituent, the substituent described above can be listed, and a substituent or non-substituent alkyl group, for example, substituted or non-substituted and linear or branched alkyl groups with a carbon number of 1 to 6 are preferred. From the standpoint of antistatic performance, an alkyl group substituted by one or more halogen atom is preferred and an alkyl group substituted by one or more fluorine atom is more preferred and a perfluoro alkyl group is still more preferred. As specific examples of perfluoro alkyl group, there are a trifluoro methyl group, a pentafluoro ethyl group and the like.

As cation to form salts with sulfonyl imide anion, it is not particularly limited and metal cation can be listed. That is, an embodiment of sulfonyl group-containing compound is metal salt of sulfonyl imide anion and metal cation. As metal ions, they are not limited to the following, and there are lithium ion (Li⁺), sodium ion (Na⁺), potassium ion (K⁺), rubidium ion (Rb⁺), cesium ion (Cs⁺), beryllium ion (Be²⁺), magnesium ion (Mg²⁺), calcium ion (Ca²⁺), strontium ion (Sr²⁺), barium ion (Ba²⁺) and the like. From the standpoint of antistatic performance, alkaline metal cation, specifically, lithium ion (Li⁺), sodium ion (Na⁺), potassium ion (k⁺) are preferred.

The sulfonyl group-containing compound can be a conductive polymer. As such polymers, there are a homopolymer or a copolymer of styrene sulfonic acid. Moreover, there is a homopolymer or a copolymer of unsaturated sulfonic acid such as vinyl sulfonic acid. Preferred is polystyrene sulfonic acid (PSS). As to the detail of the polymer of unsaturated sulfonic acid described above, paragraphs 0120 to 0121 of Japanese Unexamined Patent Publication (KOKAI) No. 2009-86244 can be referred to.

The polymer of unsaturated sulfonic acid can take the form of salt with alkaline metal ions such as Na⁺, K⁺ and the like and can be contained in the adhesive layer.

Alternatively, the polymer of unsaturated sulfonic acid can be contained in the adhesive layer in complex form. As such a complex, from a standpoint of conductive property, the complex with polythiophene polymer is preferred. Polythiophene polymer is a polymer that contains thiophene skeleton, and as to its detail, paragraphs 0110 to 0118, 0122, 0123 of Japanese Unexamined Patent Publication (KOKAI) No. 2009-86244 can be referred to. As the complex of polythiophene polymer and polystyrene sulfonic acid, poly(3,4-ethylene dioxythiophene)/polystyrene sulfonic acid complex (PEDOT/PSS) can be exemplified as a preferred embodiment. In addition, as to the detail of the adhesive layer formed with conductive resin (antistatic layer), paragraphs 0124 to 0175 of the same Japanese Unexamined Patent Publication can be referred to.

Only one type of sulfonyl group-containing compound explained above can be used, or two types or more can be combined and used. Sulfonyl group-containing compound can be synthesized using publicly known methods and many can be obtained as commercially available products.

### Layer Configuration

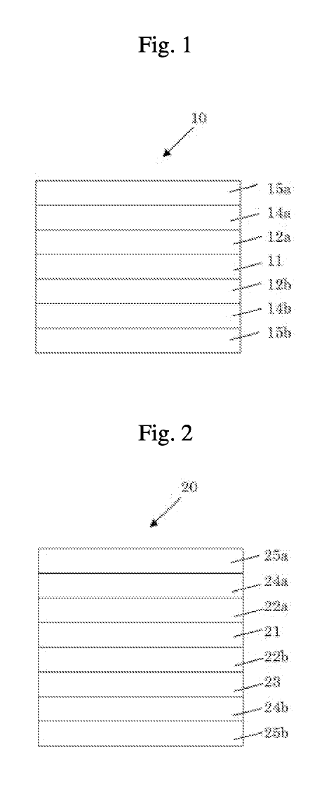

The laminated body for a polarizing plate of an aspect of the present invention can be used to produce a polarizing plate by combining with a polarizer. Specific embodiments of the polarizing plates thus obtained are shown in FIG. 1 and FIG. 2. These drawings are shown to exemplify layer configurations, and the thickness of each layer is not limited by the embodiment shown in drawings in any way.

Polarizing plate 10 shown in FIG. 1 has polymer films 12a and 12b on the surface of a polarizer 11. These polymers films can function as a role of protecting the polarizer from environmental humidity and the like. Moreover, they can function as a phase difference film. Alternatively, as an optional layer not shown in Figures, there can be a phase difference layer and other layer of one layer or more positioned between the phase difference layer and supporter film (polymer film). For example, a laminated film in which a polymer film (supporter film) and a phase difference film are directly laminated or laminated through one or more other layer can be contained in the polarizing plate as a phase difference film. This point can be applied to polarizing plate 20 shown in FIG. 2 set forth below.

On the surface of polymer film 12a, 12b are pasted peelable film 15a, 15b respectively through adhesive layer 14a, 14b. When they are pasted to a liquid crystal cell, after each peelable film 15a, 15b and the adhesive layer 14a on the side not pasted to the cell are peeled, it is pasted to the liquid crystal cell (not shown in figure) surface through adhesive layer 14b. As to polarizing plate 10 shown in FIG. 1, at least one layer of adhesive layer 14a or 14b contains aforementioned sulfonyl group-containing compound. Since a sulfonyl group-containing compound is contained therein, when polarizing plate 10 is pasted to a liquid crystal cell, and when peelable films 15a and 15b are peeled, peeling static build-up can be prevented from being generated. Thereby, erroneous operations and image disruption and the like caused by static build-up can be prevented.

FIG. 1 shows an embodiment that contains a sulfonyl group-containing compound in the adhesive layer. However, in the present invention, the layer that contains sulfonyl group-containing compound is not limited to the adhesive layer. For example, the sulfonyl group-containing compound can be contained in the layer (intermediate layer) positioned between the adhesive layer and the polymer film by directly contacting both respectively. As such intermediate layer can function as an antistatic layer, the same as above, peeling static build-up can be prevented from being generated when peelable film is peeled. In an embodiment, as the above intermediate layer, there can be an antistatic layer that contains metal salt of sulfonyl imide anion and metal cation as an antistatic agent. In an another embodiment, the intermediate layer described above can be a layer made of a conductive polymer described above.

FIG. 2 shows a schematic drawing showing the layer configuration of a polarizing plate that contains sulfonyl group-containing compound in the intermediate layer described above. Polarizing plate 20 shown in FIG. 2 comprises polymer films 22a and 22b on the surface of polarizer 21. On the surface of polymer films 22a, 22b are pasted peelable films 25a, 25b respectively through adhesive layers 24a, 24b. Intermediate layer 23 is contained between polymer film 22b and adhesive layer 24b pasted with a liquid crystal cell. This intermediate layer 23 is a layer that contains sulfonyl group-containing compound and can function as an antistatic layer.

The laminated body of an aspect of the present invention contains an aromatic secondary amine set forth below in either or both of the polymer film and the layer that contains a sulfonyl group-containing compound. Only polymer film or only the layer that contains a sulfonyl group-containing compound can contain an aromatic secondary amine or both can contain an aromatic secondary amine.

As explained before, since it is thought that strong acid generated due to change over time of the sulfonyl group-containing compound may cause the property change of polymer film, the part that is most easily subjected to property change by influence of strong acid is polymer film which directly contacts the layer that contains a sulfonyl group-containing compound. Hence, it is preferred that an aromatic secondary amine is added to such polymer film (in FIG. 1, polymer film 12b and in FIG. 2, polymer film 22b). Alternatively, by adding an aromatic secondary amine to the layer that contains a sulfonyl group-containing compound, strong acid derived from sulfonyl group-containing compound is neutralized in the layer, thereby moving strong acid to polymer film, thus changing the property of polymer film can be prevented. Moreover, in the following, when two layers exist as directly contacting layers, it is described as “adjacent”. Due to the reason described above, it is preferred that an aromatic secondary amine is contained in the layer that contains a sulfonyl group-containing compound or in the polymer film adjacent to the layer. However, sometimes, strong acid may move into the layer or between layers over time, and may reach to the polymer film that is not adjacent. From this point, it is also preferred that an aromatic secondary amine is added to polymer film not adjacent to the layer that contains a sulfonyl group-containing compound (In FIG. 1, polymer film 12a, and in FIG. 2, polymer film 22a) and in the other layer optionally provided (not shown in figure).

The layer that contains a sulfonyl group-containing compound explained above usually contains resin (binder resin) together with a sulfonyl group-containing compound. From the standpoint of enabling good antistatic performance and film strength to be compatible, it is preferred that a sulfonyl group-containing compound of 0.1 part to 10 parts is contained per resin 100 parts contained in the layer that contains the above compound, and it is more preferred that 0.5 part to 5 parts be contained.

In the embodiment set forth above that a sulfonyl group-containing conductive polymer is used, the layer can be formed only by conductive polymer, and other resin (binder resin) can be contained. If binder resin is contained, from the standpoint of obtaining good antistatic effect, the ratio of binder resin as a solid component conversion is, for example, equal to or less than 3,000 parts relative to conductive polymer 100 parts, and preferably equal to or less than 1,000 parts, more preferably equal to or less than 500 parts.

Aromatic Secondary Amine

Next, an aromatic secondary amine contained in the laminated body of an aspect of the present invention is explained.

The aromatic secondary amine is contained in at least one of the polymer film and the layer that contains a sulfonyl group-containing compound described above. Only one type of aromatic secondary amine can be used or two types or more can be combined and used. The inventor infers that as the aromatic secondary amine can act as acid-acceptor, or neutralizer, this can prevent the polymer film from changing its property by strong acid derived from sulfonyl group-containing compound and reducing transmissivity as haze is generated. However, as an aliphatic secondary amine or a primary amine is used as a basic compound, basicity may be too high and the polarizer may change its property, and thus polarizing performance of a polarizing plate may be reduced. The inventor thinks that the main factor for the above is that acid crosslinking by boric acid and the like contained in the polarizer may collapse by the basic substance. By contrast, the aromatic secondary amine comprises a structure in which two aromatic substituents are bonded to a nitrogen atom or it comprises at least one heteroaromatic ring which has nitrogen atom with one hydrogen atom substituted as a heteroatoms. It is inferred that since the aromatic secondary amine comprises —NH— site and aromatic structure as above, electron density on nitrogen atom can be reduced, and basicity can be reduced, this is the reason why property changes of the polarizer can be avoided. Furthermore, the inventor thinks that by making an aromatic structure into heteroaromatic ring, electron density can be further reduced, and enabling the reduction of basicity, thus property change of the polarizer can be further inhibited.

The aromatic secondary amine, as described above, in an embodiment, comprises a structure in which two aromatic substituents are bonded to a nitrogen atom, and represented by NH(Ar)₂. Here, Ar represents a substituted or non-substituted aryl group or a heteroaryl group, and two existing Ar can be same or different. In addition, as a substituent, one or more aromatic secondary amino group represented by —NH (Ar) can be contained. Here Ar has the same definition as the above.

Examples of the aryl group include substituted or non-substituted aryl groups, and an aryl group in which preferably, the carbon number is 6 to 30, more preferably the carbon number is 6 to 20, and still more preferably the carbon number is 6 to 12. Specific examples include a substituted or non-substituted phenyl group, naphtyl group, anthranil group, biphenyl group and the like.

Examples of the heteroaryl group include a substituted or non-substituted heteroaryl group, a heteroaryl group in which preferably the carbon number is 1 to 20, more preferably the carbon number is 2 to 15, and still more preferably the carbon number is 4 to 10. Examples of the hetero atom contained include a nitrogen atom, sulfur atoms and oxygen atom. Specific examples of the heteroaryl group include a substituted or non-substituted 2-pyridyl group, 3-pyridyl group, 4-pyridyl group, 1, 2, 3-triazinyl group, 1, 2, 4-triazinyl group, 1, 3, 5-triazinyl group and the like.

The aromatic secondary amine, as described above, in an embodiment, is a compound that contains a heteroaromatic ring which has a nitrogen atom with one hydrogen atom substituted as a hetero atom. Such a heteroaromatic ring can be single-ring or fused ring. Specific examples include, for example, heteroaromatic single rings such as a pyrrole ring, pyrazole ring, imidazole ring, triazole ring and the like, and heteroaromatic fused rings such as an indole ring, benzoimidazole ring, purine rings and the like. For the heteroaromatic rings described above, it is sufficient as long as at least one hydrogen atom with one hydrogen atom substituted is contained and hetero atoms other than the nitrogen atom such as other type pf nitrogen atoms, sulfur atoms and oxygen atoms and the like can be contained.

The heteroaromatic rings described above can be substituted or non-substituted and being substituted is preferred. As the substituent, the substituent preferably comprises the groups selected from the group consisting of an aryl group and a heteroaryl group. Regarding the aryl group and the heteroaryl group, they are as described previously regarding the aromatic secondary amine represented by NH (Ar)₂. It is thought that as to the aryl group and the heteroaryl group, by directly binding to the heteroaromatic ring described above, electron density on the nitrogen atom can be further decreased to reduce basicity. Hence, as a compound that contains a heteroaromatic ring that comprises a hetero atom in the form of the nitrogen atom with one hydrogen atom substituted, the compound is preferred in which one or more aryl group or heteroaryl group is directly bonded to a heteroaromatic ring, and the compound is more preferred in which two or more aryl group and heteroaryl group are directly bonded to a heteroaromatic ring.

The aromatic secondary amine described above preferably contains one or more, more preferably 1 to 3 heteroaromatic rings. Regarding the aromatic secondary amino group contained in the aromatic secondary amine described above, there are preferably two or more in one molecule and more preferably 2 to 3.

From the standpoint of preventing changing the property of polymer film, regarding the aromatic secondary amine described above, preferably 0.1 part to 20 parts are preferably contained per resin 100 parts contained in the film or layer that contains the above compound, more preferably 0.4 part to 10 parts, further preferably 0.8 part to 10 parts, and still more preferably, 1 part to 10 parts.

The aromatic secondary amine described above can be synthesized by publicly known methods, and many can be obtained by commercially available products.

Details of the layer that contains the sulfonyl group-containing compound and polymer film described above are described later.

[Polarizing Plate]

The polarizing plate of an aspect of the present invention comprises the laminated body for a polarizing plate described above and a polarizer. The specific embodiments of the layer configuration of the polarizing plate of an aspect of the present invention are as in FIG. 1 and FIG. 2. However, the polarizing plate of an aspect of the present invention is not limited to the embodiments shown in FIG. 1 and FIG. 2, and an aspect of the present invention includes the embodiment in which, for example, the layers not shown in drawings are contained in optional positions.

The following explains about each member comprised in the polarizing plate of an aspect of the present invention.

Polymer Film

A polymer film can be single layer film or a laminated film in which two or more polymer films are laminated. When the aromatic secondary amine is contained in a polymer film that is a laminated film, the aromatic secondary amine is contained at least in one layer of the film that constitutes a laminated film.

As a polymer that constitutes a polymer film, a polymer that is normally used to constitute a film contained in a polarizing plate to protect a polarizer and the like can be used without any limitation. Examples thereof include polyester polymers such as polyethylene terephthalate, polyethylene naphthalate and the like; cellulose polymers such as diacetyl cellulose, triacetyl cellulose and the like; acrylate polymers such as polymethyl methacrylate and the like; polycarbonate polymers and the like. As protective films for a polarizer, among polymer films made of polymers exemplified above, a cellulose polymer film and an acrylate polymer film are preferred and a cellulose polymer film, particularly a cellulose acylate film is preferred.

Regarding a cellulose acylate film, it is known that optical characteristics of the film depend on the acyl substitution degree of cellulose acylate. Particularly regarding cellulose acylate with low substitution degree, since its specific birefringence is high, by reducing acyl substitution degree, a high optical expression property can be realized that are suited to VA (vertical alignment) phase difference films, IPS (in-plane switching) phase difference films or the supporter film for the phase difference film. On the other hand, a cellulose acylate film with high acyl substitution degree is advantageous for production suitability. Hence, as a polymer film which does not demand high optical characteristics, a cellulose acylate film with high acyl substitution degree can be used. From the above points, as an embodiment of VA polarizing plate, one with low acyl substitution degree can be used as a cellulose acylate film positioned on the liquid crystal cell side of a polarizer, and as the cellulose acylate film positioned on the opposite side, one with high acyl substitution degree can be used. On the other hand, regarding cellulose acylate film with high acyl substitution degree, its specific birefringence is close to zero, so it can be used favorably for a so-called IPS zero retardation film. Or a polymer film can be a laminated film that contains two or more layers of cellulose acylate films with a different composition. In this case, acyl substitution degree of each cellulose acylate film contained in the laminated film, types and amounts of additives contained in the film can be suitably selected depending on the property that is demanded for a film.

The polymer film described above can be produced using a publicly known method such as a solvent cast method (solution casting film forming method) and the like. For example, by adding the aromatic secondary amine as an additive to dope used in the solvent cast method, the polymer film that contains the above compound can be obtained. Into polymer film can be added additives selected depending on the needs, along with the aromatic secondary amine or separately from the aromatic secondary amine. As to details of additives, for example, paragraphs 0040 to 0126 of Japanese Unexamined Patent Publication (KOKAI) No. 2012-225994, which is expressly incorporated herein by reference in its entirety, can be referred to.

As to the thickness of a polymer film, with respect to the polymer film positioned between a polarizer and a liquid crystal cell, from the standpoint of maintaining optical characteristics, film thickness of equal to or less than 80 μm is preferred, the range of 15 μm to 70 μm is more preferred and the range of 20 μm to 65 μm is further preferred. In case of a laminated film with two or more layers, two layers or three layers configuration is preferred. In case of a laminated configuration with three or more layers, the layer inside the film is called as a core layer. As to a three layered film, the film preferably includes a surface layer on the side that contacts the supporter (also referred to as a supporter layer, hereinafter) during the solution film formation of the polymer film, the surface layer on the opposite side from the side that contacts the supporter (also referred to as an air layer, hereinafter), and a core layer which is a thicker film than those surface layers. On the other hand, as to a two layered film, the film includes a surface layer on the side that contacts the supporter (also referred to as a supporter layer, hereinafter) during the solution film formation of the polymer film and other layer (also referred to as a core layer, hereinafter).

Regarding a cellulose acylate film, it is preferred that the film thickness of the core layer described above is equal to or less than 78 μm; the range of 13 μm to 68 μm is further preferred; and the range of 18 μm to 62 μm is still further preferred. It is preferred that film thickness of the supporter layer is equal to or less than 10 μm, for example it is within a range of 1 μm to 10 μm. The preferred range of the air layer of the three layered film is the same as the preferred range of the supporter layer.

The polymer film positioned on the opposite side from the liquid crystal cell of a polarizer can mainly function as a protective film, and the film thickness is not particularly limited.

It is preferred that the range of the film width of a polymer film is 700 mm to 3,000 mm, and it is more preferred that the range is 1000 mm to 2800 mm, and it is further preferred that the range is 1300 mm to 2500 mm.

In addition, polymer films, among them, a polymer film that can be used as a supporter film contained in the phase difference film (laminated film) described below can be also referred to, for example, in paragraphs 0018 to 0020 of Japanese Unexamined Patent Publication (KOKAI) No. 2013-235232, which is expressly incorporated herein by reference in its entirety.

In an embodiment, by forming a phase difference layer directly on a polymer film surface or through other layer, a phase difference film can be formed as a laminated film having a polymer film in the form of a supporter film. In an embodiment, the polymer film described above can be contained in the polarizing plate of an aspect of the present invention as the supporter film of such a phase difference film. Regarding phase difference layers and other layers that can be between the phase difference layer and polymer film, a publicly known technique regarding phase difference films can be applied without any limitation. Regarding phase difference layers, for example, paragraphs 0141 to 0187 of Japanese Unexamined Patent Publication (KOKAI) No. 2013-235232 can be referred to. Regarding other layers that can be between the phase difference layer and supporter film, examples thereof include an acrylic resin-containing layer and a polyvinyl alcohol resin-containing layer. Regarding such layers, for example, paragraphs 0121 to 0140 of Japanese Unexamined Patent Publication (KOKAI) No. 2013-235232 can be referred to. Furthermore, as to details of phase difference films (laminated film), paragraphs 0188 to 0196 of Japanese Unexamined Patent Publication (KOKAI) No. 2013-235232 can be also referred to.

Polarizer

A polarizer is not particularly limited and various types can be used. As a polarizer, for example, the following polarizing films and the like can be used: the polarizing films prepared as follows—dichroic substances such as iodine or dichroic dyes and the like are adsorbed to hydrophilic polymer films such as polyvinyl alcohol films, partially formal-modified polyvinyl alcohol films, ethylene and vinyl acetate copolymer film with a part saponified and the like, and the result is uniaxial stretched; polyene-based polarizing film such as polyvinyl alcohol dehydration-processed product or polyvinyl chloride dechlorination-processed product and the like. Among them, the former is commonly used. The orientation of a polarizer is normally fixed by cross-linking stretched polyvinyl alcohol with acids such as boric acid. As described above, if an aliphatic secondary amine and a primary amine are used as a basic compound, a collapse of the acid cross linking is thought to cause deterioration of polarizing characteristics by using these amines. By contrast, in the present invention, as a basic compound, an aromatic secondary amine is used, so the deterioration of polarizing characteristics cannot be caused, and the polymer film can be prevented from changing its property by the aforementioned strong acid.

As to the thickness of a polarizer, there is no particular limitation. As to the thickness of the entire polarizing plate, a thinner one is preferred. From this point, it is preferred that the thickness of a polarizer is about 5 μm to 40 μm.

Layer that Contains Sulfonyl Group-Containing Compound

As explained referring to FIG. 1 and FIG. 2, the layer that contains a sulfonyl group-containing compound can be an adhesive layer. In such a case, an adhesive layer can function as an antistatic layer. On the other hand, the layer that contains a sulfonyl group-containing compound can be the layer (intermediate layer) positioned between the adhesive layer and polymer film as a separate layer from an adhesive layer. This intermediate layer can function as an antistatic layer.

Both of the adhesive layer and intermediate layer can be formed by applying a coating solution and drying it. Examples of the coating method include rotation coating, dip coating, spray coating, bar coating, bead coating by a continuous coating machine, bar coating by a continuous coating machine, hopper coating by a continuous coating machine, Wick method by moving continuously and the like, but the coating method is not limited. The above layer can be formed by, as needed, heating the coating layer that has been formed and removing the solvent. For the coating layer that contains a curable material, in order to advance curing, it is preferred that curing processing such as photo irradiation, heating and the like on the coating layer is provided. Curing conditions can be set depending on materials used. Regarding solvents that can be used to prepare the coating solution, for example, paragraph 0017 of Japanese Unexamined Patent Publication (KOKAI) No, 2009-229956, which is expressly incorporated herein by reference in its entirety, can be referred to.

When the layer that contains a sulfonyl group-containing compound is the intermediate layer described above, from the standpoint of improving durability, it is preferred that binder is included in the layer. Binder can be added into the coating solution described above. Examples of the binder include vinyl acetate resin, vinyl chloride—vinyl acetate resin, vinyl acetate—methyl methacrylate copolymer, methyl methacrylate—methacrylic acid copolymer, cellulose acetate butyrate and the like, but the binder is not limited to those.

As the binder, conductive polymers such as polythiophene, polyaniline and the like can be used. By using such conductive polymers, antistatic effect by conductive polymer can be obtained in addition to antistatic effect by the sulfonyl group-containing compound. As to details of such conductive polymers, for example, paragraphs 0026 to 0034 of Japanese Unexamined Patent Publication (KOKAI) No. 2012-20711, which is expressly incorporated herein by reference in its entirety, can be referred to. The intermediate layer described above can also be formed with the use of conductive polymers containing a sulfonyl group-containing compound described above.

Using the coating solution that contains curable materials is preferred in forming a layer that is high in hardness and superior in durability. It is sufficient for the curable material to be able to form a coating film by curing processing during coating or after coating. Various monomers, prepolymers, crosslinking agents and the like can be used. As to details of curable materials, for example, paragraph 0024 of Japanese Unexamined Patent Publication (KOKAI) No. 2009-229956, paragraphs 0121 to 0124 of Japanese Unexamined PatentPublication (KOKAI) No. 2012-207110, which is expressly incorporated herein by reference in its entirety, can be referred to.

As adhesive agents contained in an adhesive layer, those containing base polymer such as acrylic polymer (include copolymer), silicone polymer, polyester, polyurethane, polyamide, polyether, fluorine-based polymer, rubber-based polymer and the like can be suitably selected for use. From the standpoint of optical transparency, adhesive characteristic, weatherability, heat resistance and the like, acrylic adhesive is preferred. For details of acrylic adhesive, for example, paragraphs 0023 to 0031 of published Japanese translation of PCT international publication for patent application (TOKUHYO) No. 2010-525098, paragraphs 0025 to 0030 of Japanese Unexamined Patent Publication (KOKAI) No. 2009-229956, and paragraphs 0093 to 0121 of Japanese Unexamined Patent Publication (KOKAI) No. 2012-207110 can be referred to.

As adhesive agents, commercially available acrylic resins can be favorably used. Specific examples of commercially available products are, for example, Corpneal N3816E (made by Nippon Gosei Kagaku Corp), SK Dine 1811L (made by Soken Kagaku Corp), SK Dine 2147 (made by Soken Kagaku Corp), SK Dine 1435 (made by Soken Kagaku Corp), SK Dine 1415 (made by Soken Kagaku Corp), Olibain EG-655 (made by Toyo Ink Seizo Corp) and the like.

In the intermediate layer and adhesive layer described above, various additives can be contained, as needed. Examples of the additives include surface lubricants, leveling agents, anti-oxidants, antiseptic agents, light stabilizers, ultraviolet absorbent, polymerization inhibitors, silane coupling agents and the like.

The thickness of intermediate layers explained above is, for example, equal to or more than 2 nm and less than 2 μm, and from the standpoint of antistatic property and optical transparency, it is preferred that it is equal to or more than 2 nm and equal to or less than 1 μm. On the other hand, the thickness of an adhesive layer is, for example, equal to or more than 3 μm and equal to or less than 100 μm, and from the standpoint of optical transparency, it is preferred that it is equal to or more than 5 μm and equal to or less than 50 μm.

Normally, to prevent dust from attaching on the surface during storage, conveying or the like, a peelable film is pasted on both surfaces of a polarizing plate before pasted with a liquid crystal cell. The polarizing plate of an aspect of the present invention also is preferred to contain a peelable film on both surfaces. As peelable films, commercially available products such as peelable sheets and peelable paper and the like can be used without any limitation. In an embodiment, in the adhesive layer of a peelable film, the sulfonyl group-containing compound described above can be contained.

Static build-up generated when the peelable film described above is peeled may cause display failure of a liquid crystal display device with a polarizing plate assembled therein. In addition, dust attachment by static build-up may cause display failure. Particularly if dust is attached to the pasting surface with a liquid crystal cell by static build-up, it is difficult to remove afterward. In preventing such static build-up, as shown in FIG. 1 and FIG. 2, it is effective to provide a layer that contains a sulfonyl group-containing compound between the peelable film and the polymer film.

In addition, regarding a configuration of a polarizing plate, paragraphs 0197 to 0199 of Japanese Unexamined Patent Publication (KOKAI) No. 2013-235232 can also be referred to.

[Liquid Crystal Display Device]

The liquid crystal display device of an aspect of the present invention comprises the polarizing plate of an aspect of the present invention and a liquid crystal cell. The liquid crystal display device of an aspect of the present invention can be designed such that the polarizing plate of an aspect of the present invention can be provided at least on one side of the viewing side of the liquid crystal cell (front side) and back light side (rear side), or it can be on both. Static build-up generated on a polarizing plate on viewing side may greatly impact on display performance and the like of the liquid crystal display device. From this stand point, it is preferred that the polarizing plate of an aspect of the present invention that contains a sulfonyl group-containing compound that can functions as an antistatic agent is positioned at least on the viewing side of the liquid crystal cell.

In the liquid crystal display device of an aspect of the present invention, the thickness of glass that constitutes the liquid crystal cell is preferred to be within the range of 50 μm to 500 μm. By using such thickness glass, thinning of a liquid crystal display becomes possible.

An embodiment of the liquid crystal display device of an aspect of the present invention is a VA, IPS or OCB (optically compensated bend) mode liquid crystal display device comprising a liquid crystal cell and a pair of polarizing plates positioned on both sides of the liquid crystal cell, and at least one side of the polarizing plate is the polarizing plate of an aspect of the present invention. For example, as the configuration of a liquid crystal display device of VA mode, one example is the configuration as shown in FIG. 2 of Japanese Unexamined Patent Publication (KOKAI) No. 2008-262161, which is expressly incorporated herein by reference in its entirety. However, there is no limitation to a specific configuration of a liquid crystal display device. For example, various publicly known configurations such as the configuration described in paragraphs 0200 to 0201 of Japanese Unexamined Patent Publication (KOKAI) No. 2013-235232 can be adopted.

As explained above, according to an aspect of the present invention, static build-up of a polarizing plate and property change of the polymer film contained in a polarizing plate can be prevented. By adopting such a polarizing plate as a constituent member of a liquid crystal display device, a liquid crystal display device with superior display performance can be provided.

### EXAMPLES

The present invention is specifically explained based on the following examples. The materials, reagents, substance amounts and the ratios, operations and the like can be suitably changed as long as they do not deviate from the intent of the present invention. Hence, the scope of the present invention is not limited to the following specific examples.

Amines used in Examples and Comparative Examples are shown in the following Table 1.

TABLE 1

| | |
|---|---|
| A1 | Diphenylamine |
| A2 | 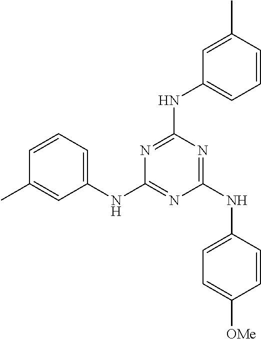 [SMILES: COc1ccc(Nc2nc(Nc3cccc(C)c3)nc(Nc3cccc(C)c3)n2)cc1] |
| A3 | 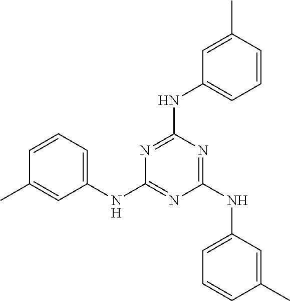 |
| A4 | Benzoguanamine |
| | (made by Nihon Shokubai Corp) |
| A5 | 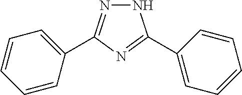 [SMILES: c1ccc(-c2n[nH]c(-c3ccccc3)n2)cc1] |

The additives used in Examples and Comparative Examples are shown in the following Table 2.

TABLE 2

| | |
|---|---|
| UV1 | 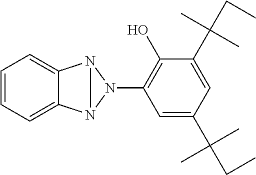 [SMILES: CCC(C)(C)c1cc(-n2n3c4ccccc4n23)c(O)c(C(C)(C)CC)c1] |
| UV2 | 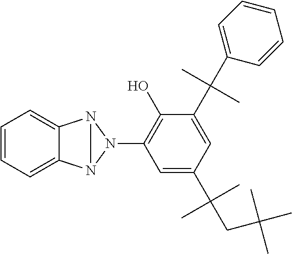 [SMILES: CC(C)(C)CC(C)(C)c1cc(-n2n3c4ccccc4n23)c(O)c(C(C)(C)c2ccccc2)c1] |

| | |
|---|---|
| Addi- | TPP/BDP (=2:1) |
| tive T | |
| Addi- tive S | 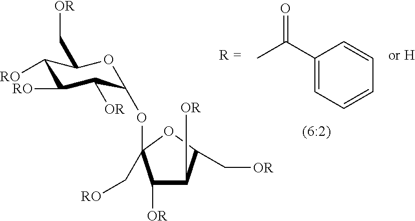 |
| Addi- tive R | 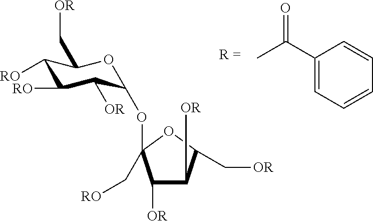 |
| Addi- tive P | 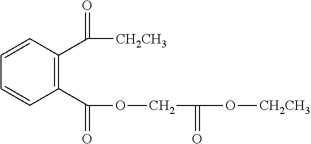 [SMILES: CCOC(=O)COC(=O)c1ccccc1C(=O)CC] |
| | 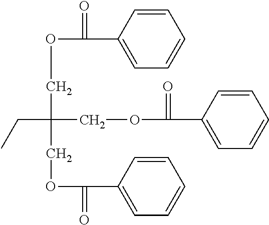 [SMILES: CCC(COC(=O)c1ccccc1)(COC(=O)c1ccccc1)COC(=O)c1ccccc1] |
| | Mixing ratio 1:1 |

(In the table, TPP: tripheyl phosphate, BDP: biphenyl diphenyl phosphate, mixing ratio: weight ratio)

1. Preparation Example of Cellulose Acylate Films

(Preparation of Film 1)

In the following explanation, in forming film by cocasting, the layer formed from the main flow is a core layer, the layer on supporter surface side is a supporter layer, and the layer on opposite side of the supporter layer is an air layer.

### (1) Preparation of Dope 1 for a Core Layer.

Dope 1 for the core layer with the following composition was prepared.

Dope 1 composition

| | | |
|---|---|---|
| Cellulose acylate (acyl substitution degree 2.88, number | 100 | parts |
| average molecular weight 72,000) | | |
| Methylene chloride (first solvent) | 320 | parts |
| Methanol (second solvent) | 83 | parts |
| 1-butanol (third solvent) | 3 | parts |
| Additive T | 10 | parts |
| Additive UV1 | 1 | parts |

Specifically, core layer dope 1 was prepared using the following method.

While the mixed solvent described above was stirred and dispersed in a 4,000L stainless steel dissolution tank with stirring blades, cellulose acetate powder (flakes), additive T and UV1 were gradually added, and it was prepared so that the total becomes 2,000 kg. As to solvents, those in which water containing rate was equal to or less than 0.5 weight percent were used. First, regarding cellulose acetate powders, the powders were injected into a dispersion tank, using a dissolver type eccentric stifling shaft that initially stirs at a peripheral speed of a stifling shearing speed of 5 m/sec (shearing stress 5×10⁴ kg f/m/sec²), under the conditions in which the central shaft has an anchor wing, and stirs with a peripheral speed 1m/sec (shearing stress 1×10⁴ kg f /m/sec²), the powders were dispersed for 30 minutes. The dispersion start temperature was 25° C., and the final arrival temperature ended up with 48° C. After completing dispersion, high speed stirring stopped, and the peripheral speed of an anchor wing was set to 0.5 m/sec and it was stirred for 100 minutes more to swell cellulose acetate flakes.

Swollen solution was heated to 50° C. in a pipe equipped with a jacket from the tank, furthermore, it was heated to 9° C. to completely dissolve. Heating time was 15 minutes. Next, the temperature was decreased to 36° C. and the filtering material with official pore diameter 8 μm was passed and to dope was obtained.

Dope before condensation thus obtained was flushed inside the tank of a normal pressure at 80° C. and evaporated solvent was recovered and separated by a condenser. Solid component concentration of the dope after flushing was 21.8 weight percent. As to the flush tank, one with anchor wing in the center shaft was used, and it was stirred at a peripheral speed 0.5 m/sec and defoamed. The temperature of dope inside the tank was 25° C. and the average retention time in the tank was 50 minutes.

After that, while in a state of being pressurized to 1.5 MPa, initially, a sintered fiber metal filter of an official pore diameter 10 μm was passed through, next, a sintered fiber filter of an official pore diameter 10 μm was likewise passed through. The dope temperature after filtering was adjusted to 36° C. and stored in the 2,000 L stock tank made of stainless steel. For a stock tank, one with anchor wing in the center shaft was used, and by stirring at a peripheral speed 0.3 m/sec steadily, core layer dope 1 was obtained.

(2) Preparation of Supporter Layer Dope 2

Mat agent (silicon dioxide (particle diameter 20 nm)) and core layer dope 1 described above were mixed via a static mixer, and a supporter layer dope 2 was prepared. Regarding amounts added, it was done so that the total solid component concentration ended up with 20.2 weight percent, and mat agent concentration ended up with 0.033 weight percent.

(3) Preparation of Air Layer Dope 3

Mat agent (silicon dioxide (particle diameter 20 nm)) was mixed via a static mixer into the core layer dope 1, thus the air layer dope 3 was prepared. Regarding amounts added, it was done so that the total solid component concentration ended up with 20.2 weight percent, mat agent concentration ended up with 0.033 weight percent.

(4) Preparation of a Cocasting Film

As a casting die, a feed block prepared for cocasting was provided, and a device was used so that in addition to a main flow, both sides are laminated to form a three layered film. For the dope sending paths, three flow paths for a core layer, a supporter layer and an air layer were used.

Core layer dope 1, supporter layer dope 2 and air layer dope 3 described above were cocast from the casting opening over a drum cooled to −5° C. At this time, each dope flow amount was adjusted so that the ratio of completed thickness was air layer/core layer/supporter layer=3 μm/74 μm/3 μm. Casted dope film was subjected to 34° C. dry wind at 230 m³/min over the drum, and they were dried and peeled from the drum. When peeling, they were stretched by 17 percent in conveying direction (longitudinal direction). After that, while both ends of width direction (direction orthogonal to casting direction) of the film was grasped by a pin tenter (pin tenter described in FIG. 3 of Japanese Unexamined Patent Publication (KOKAI) Heisei No. 4-1009, which is expressly incorporated herein by reference in its entirety), and they were conveyed. Furthermore, they were conveyed between the roll of a heat processing device, and dried more, and a film 1 with thickness 80 μm was prepared.

(Preparation of Films 2 to 12, 18)

One or more of the additive type, additive amounts added to dope 1 for core layer, dope 2 for supporter layer, dope 3 for air layer, and film thickness were changed as shown in Table 4, other than that, using the same method in preparation of film 1, the films 2 to 12, and 18 were obtained. Regarding films that are different from the film thickness from film 1, the ratio of the thickness of air layer, core layer and supporter layer with respect to film thickness (total film thickness) were set up to be the same as film 1 and prepared. Moreover, for films 6 to 12 and 18, the amines shown in Table 4 for all of the core layer, supporter layer and air layer were added so that the total amount of amine additive amount of all of the above layers with respect to resin contained in all of the above layers have the values as shown in Table 4.

(Preparation of Films 13 to 17, 20, 21, Supporter Film of Phase Difference Film 19)

### (1) Dope Preparation

### <1-1> Cellulose Acylate Solution.

The fowling composition was injected into a mixing tank and stirred, then after each component was dissolved, the solution was filtered using a filter paper of 34 μm of average pore diameter and a sintered metal filter of average pore diameter 10 μm.

Cellulose acylate solution

| | |
|---|---|
| Cellulose acylate (acyl substitution degree: described | 100.0 parts |
| in Table 4, the number average molecular weight 76,000) | |
| Dichloromethane | 403.0 parts |
| Methanol | 60.2 parts |

<1-2> Mat Agent Dispersion Liquid

The following composition that contains cellulose acylate solution made by the above method was injected into a dispersion machine to prepare mat agent dispersion liquid.

Mat agent dispersion liquid

| | |
|---|---|
| Silica particles with average particle diameter 16 nm (Aerosol | 2.0 parts |
| R972 made by Nihon Airosil Corp) | |
| Dichloromethane | 72.4 parts |
| Methanol | 10.8 parts |
| Cellulose acylate solution | 10.3 parts |

<1-3> Additive Solution

Cellulose acylate solution made by the above method was injected into a mixing tank, and while being heated, stirred and dissolved, each additive described in the table was added, to prepare an additive solution. Regarding films 15 to 17, amines shown in Table 4 were added so that the value shown in Table 4 was attained.

Oligomers A to E shown in Table 4 have the compositions shown in the Table 3 described below.

TABLE 3

| | Dicarboxylic acid | | |
|---|---|---|---|
| | TPA | PA | AA |
| | (Terephthalic acid) | (Phthalic acid) | (Adipic acid) |
| | 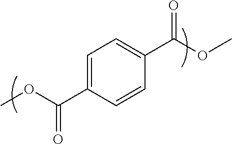 | 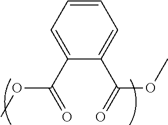 | 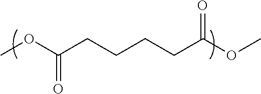 |
| Oligomer A | 50 | 0 | 50 |
| Oligomer B | 50 | 0 | 0 |
| Oligomer C | 100 | 0 | 0 |
| Oligomer D | 0 | 100 | 0 |
| Oligomer E | 0 | 0 | 100 |
| | | Diol | |
| | Dicarboxylic acid | | PG |
| | SA | EG | (Propylene |
| | (Succinic acid) | (Ethylene glycol) | Glycol) |
| | 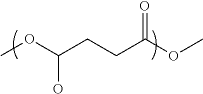 | 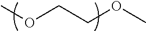 | 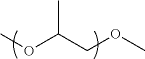 |
| Oligomer A | 0 | 50 | 50 |
| Oligomer B | 50 | 50 | 50 |
| Oligomer C | 0 | 0 | 100 |
| Oligomer D | 0 | 0 | 100 |
| Oligomer E | 0 | 100 | 0 |
| | | | Number |
| | | | average |
| | | | molecular |
| | | Terminal | weight |
| | Oligomer A | Ac | 600 |
| | Oligomer B | Ac | 700 |
| | Oligomer C | tolyl | 500 |
| | Oligomer D | Ph | 500 |
| | Oligomer E | Ac | 1000 |

(In the table, Ac represents an acetyl group, tolyl represents a tolyl group and Ph represents a phenyl group)

100 weight parts of the cellulose acylate solution, 1.35 weight parts of the mat agent solution, and the additive solution were mixed, and the dope for film formation was prepared. Cellulose acylate and various additives used as raw materials for dope were dried beforehand for 2 hours at 120° C. using a silo made by Nara Kikai Mfg. The additive amounts in Table 4 are the additive amount (weight parts) of each additive when cellulose acylate amount in the dope for film formation is set to 100 weight parts. Regarding the ratio of the additive solution added, amount (weight parts) of each additive added when cellulose acylate amount is set to 100 parts becomes the value described in Table 4.

(Casting)

The dope for film formation was cast using a metal band casting machine. Dry wind of air feeding temperature 80° C. to 130° C. (exhaust temperature was 75° C. to 120 eC) was blown from both of the back surface and front surface of the band to dry, then when residue volatile portion was 30 percent, it was peeled off from the band.

(Stretching)

Regarding films 13 to 17, 20 and 21, after peeled off from the band described above, when residue solvent concentration was 10 percent, the films were stretched by 30 percent in film width direction at stretching temperature 160° C. in tenter zone, thus a cellulose acylate film was prepared.

Regarding the supporter film of phase difference film 19, when residue solvent concentration was 0 percent, the film was stretched by 70 percent in film width direction at stretching temperature 190° C. in a tenter zone, and a cellulose acylate film was prepared.

2. Example of Preparation of Phase Difference Film

(Preparation of Phase Difference Film 19)

### (1) Saponification

The supporter film made above was dipped for 3 minutes in 2.3 mol/L of sodium hydroxide aqueous solution (solution temperature 55° C.). After that, the film was washed in water washing bath at room temperature and using 0.05 mol/L sulfuric acid at 30° C., it was neutralized. Again, the film was washed in water washing bath at room temperature and furthermore, dried in warm wind at 100° C. In this manner, saponification treatment of the surface of supporter film was performed.

(2) Formation of Acrylic Resin-Containing Layer

100 parts of acrylic mixture (ACR1 described below: ACR2 described below=67:33 weight ratio); 4 parts of photo initiator (Irugacure (Japanese registered trademark) 127) made by BASF), and MIBK (methyl isobutyl ketone)/methyl acetate (=30:70 weight ratio) solution were mixed, and a composition for forming an acrylic resin-containing layer was prepared so that 20 weight percent was attained. The composition thus prepared was coated on the supporter film surface described above using wire bar coater of #1.6. and after drying for 0.5 minutes at 60° C., to crosslink acrylic mixture, and using 120 W/cm high pressure mercury lamp, ultraviolet was irradiated for 30 seconds at 30° C. The film thickness of acrylic resin-containing layer thus formed was 0.5 μm.

ACR1: Blemmer (Japanese registered trademark) made by NOF Corp) GLM (compound with the following structure)

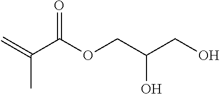

ACR2: KAYARAD (Japanese registered trademark) PET30 made by Nihon Kayaku Corp (compound with the following structure) (mixture of pentaeryrthritol triacrylate/pentaerythritol tetraacrylate)

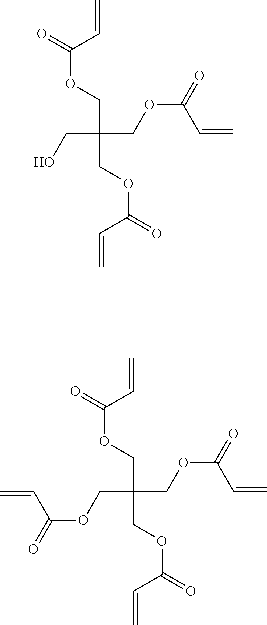

(3) Formation of Phase Difference Layer

On the surface of the acrylic resin-containing layer formed as above, 1.8 g of mixed liquid crystal (the following B01: the following B02=90:10 weight ratio), 0.06 g of photo initiator (Irgacure 907 made by BASF), 0.02 g of sensitizer (Kayacure (Japanese registered trademark) DETX made by Nihon Kayaku Corp), and 10.002 g of homeotropic agent (the following S01) were dissolved into 9.2 g of methyl ethyl ketone/cyclohexanone (=86/14 (weight ratio), and the solution thus prepared was coated using #3.2 wire bar coater to form a coating layer. Supporter film with the coating layer thus formed on the surface of the acrylic resin-containing layer was pasted to the metal frame, then it was heated for 2 minutes in constant temperature vessel at 1000, and the rod-shaped liquid crystal compound was given an orientation (homeotropic orientation). Next, after cooling to 50° C., using an air cooled metal halide lamp (made by I Graphic Corp) of 160 W/cm with oxygen concentration about 0.1 percent under nitrogen purge, ultraviolet of illumination intensity of 190 mW/cm², irradiance level 300 mJ/cm² was irradiated to cure the coating layer. After that, it was left to cool to the room temperature.

In this manner, phase difference film (IPS phase difference film) 19 with phase difference layer was obtained via acrylic resin-containing layer on supporter film (cellulose acylate film).

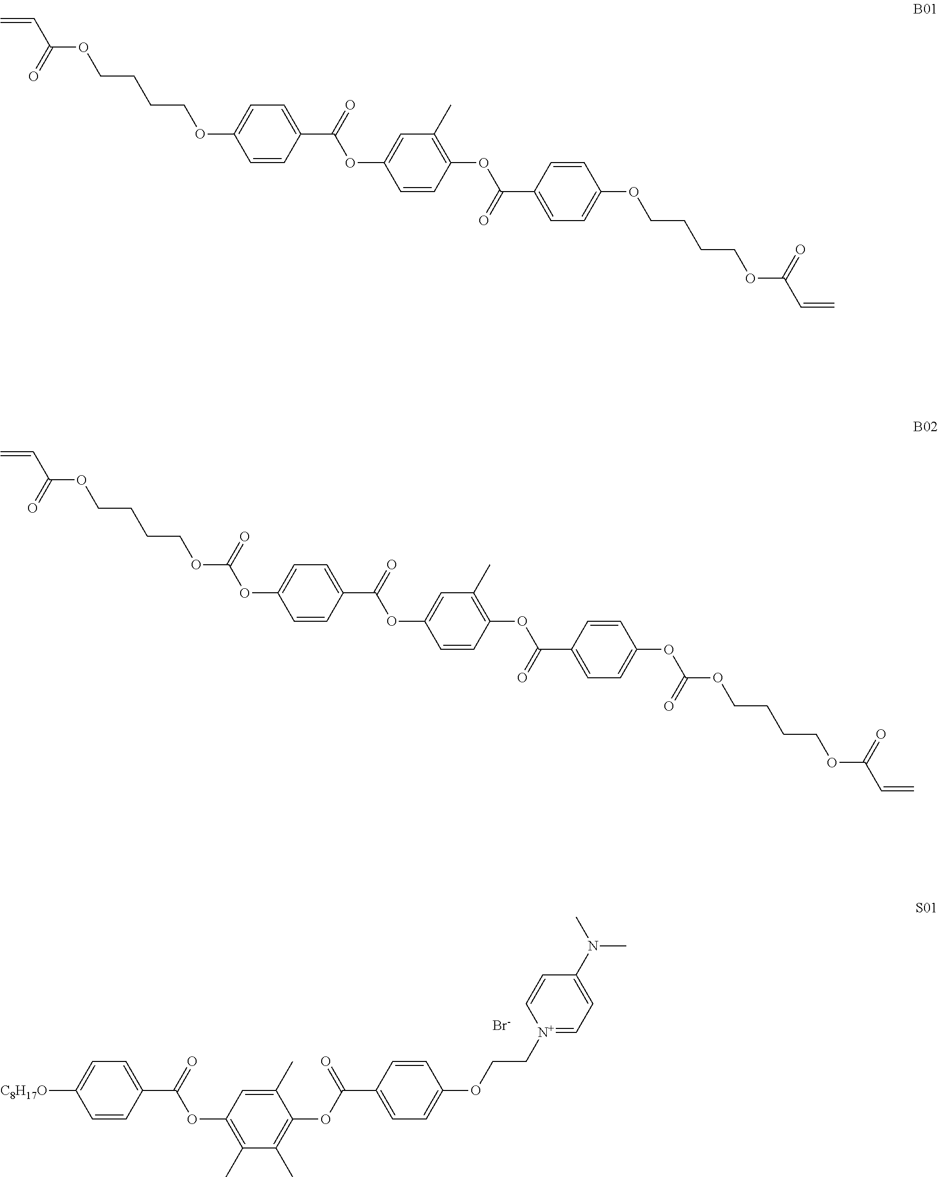

TABLE 4

| | Cellulose acylate | | | | | Film |
|---|---|---|---|---|---|---|
| | Acyl substitution | | Additive 1 | Additive 2 | Amine compound | thickness |
| | degree | Substituen | (weight percent) | (weight percent) | (weight percent) | (μm) |
| Film 1 | 2.88 | Ac | Additive T: 10 | UV1: 1 | — | 80 |
| Film 2 | 2.88 | Ac | Oligomer A: 10 | UV2: 2 | — | 40 |
| Film 3 | 2.88 | Ac | Additive S: 10 | UV1: 2 | — | 40 |
| Film 4 | 2.88 | Ac | Oligomer D: 5 | UV2: 1 | — | 60 |
| Film 5 | 2.88 | Ac | Additive P: 5 | UV2: 1 | — | 40 |
| Film 6 | 2.88 | Ac | Additive T: 10 | UV1: 1 | A4: 5 | 80 |
| Film 7 | 2.88 | Ac | Additive T: 10 | UV1: 1 | A1: 1 | 80 |
| Film 8 | 2.88 | Ac | Oligomer A: 10 | UV2: 2 | A1: 0.4 | 40 |
| Film 9 | 2.88 | Ac | Oligomer A: 10 | UV2: 2 | A3: 0.5 | 40 |
| Film 10 | 2.88 | Ac | Additive S: 10 | UV1: 2 | A3: 1 | 40 |
| Film 11 | 2.88 | Ac | Oligomer D: 5 | UV2: 1 | A3: 0.5 | 60 |
| Film 12 | 2.88 | Ac | Additive P: 5 | UV2: 1 | A3: 1 | 40 |
| Film 13 | 2.43 | Ac | Oligomer B: 19 | — | — | 60 |
| Film 14 | 2.5 | Pr/Ac = 0.9/1.6 | Oligomer C: 2 | Additive R: 8 | — | 40 |
| Film 15 | 2.82 | Ac | Additive T: 12 | — | A2: 7 | 80 |
| Film 16 | 2.43 | Ac | Oligomer B: 19 | — | A3: 2 | 40 |
| Film 17 | 2.5 | Pr/Ac = 0.9/1.6 | Oligomer C: 2 | Additive R: 8 | A1: 0.4 | 40 |
| Film 18 | 2.88 | Ac | Oligomer E: 25 | — | A2: 0.5 | 35 |
| Supporter of Film 19 | 2.43 | Ac | Oligomer B: 19 | — | A3: 5 | 40 |
| Film 20 | 2.43 | Ac | Additive S: 10 | — | A5: 2.5 | 30 |
| Film 21 | 2.43 | Ac | Additive S: 10 | — | A5: 5 | 30 |

(In the table, Pr: propionyl group: Ac: acetyl group)

3. Preparation of Polarizer

A polyvinyl alcohol film in which the refractive index at the wavelength 380 nm was 1.545, the refractive index at the wavelength 780 nm was 1.521 and the thickness was 75 μm, was uniaxially stretched with the stretching ratio 2.5, and it was dipped for 240 seconds in the 30° C. aqueous solution containing 0.2 g/L of iodine and 60 g/L of potassium iodide, next, as soon as it was dipped in aqueous solution containing 70 g/L of boric acid and 30 g/L of potassium iodide, it was uniaxially stretched with the stretching ratio 6.0 and held for 5 minutes. Lastly, it was dried for 24 hours at room temperature and a polarizer P with an average thickness 30 μm and polarizing degree of 99.95 percent was obtained.

4. Preparation of Polarizing Plates

Using cellulose acylate films 1 to 18, 20, 21 made in above 1, or a phase difference film 19 made in above 2, polarizing plates were made according to the following processes 1 to 5 so that the display surface side, when used as the viewing side of polarizing plate, as well as the film position of liquid crystal cell side, were as in Table 5.

Process 1: dipping for 90 seconds at 45° C. in 1.5 mole percent potassium hydroxide solution, followed by washing in water and drying, and the surface of cellulose acylate film was saponified.

Process 2: the above polarizer was dipped for 1 to 2 seconds in polyvinyl alcohol adhesive vessel of 2 weight percent of solid component.

Process 3: removing the excess adhesive that was attached to the polarizer at process 2, the polarizer was sandwiched with two sheets of films processed by process 1 and positioned

Process 4: back surface side of cellulose acylate film laminated by process 3 (cellulose acylate film side) was pasted with pressure 20 N/cm² to 30 N/cm², and the conveying speed about 2 m/minute.

Process 5: the sample with the polarizer and cellulose acylate film made in process 4 pasted was dried for 5 minutes by 80° C. dryer, thus a polarizing plate was made. Regarding cellulose acylate films 1 to 12 and 18, pasting was done such that the surface on air surface side opposite of the supporter (drum) during casting of cellulose acylate film was made to contact the polarizer P, and as to cellulose acylate films 13 to 17, 20 and 21, in pasting, the surface on the supporter (band) side during casting of cellulose acylate film was made to contact the polarizer P.

Regarding phase difference film 19, the opposite surface from the surface that formed the phase difference layer of supporter was pasted to contact the polarizer P.

5. Preparation of Adhesive Layer a Containing Antistatic Agent

100 weight parts of acrylic resin solution which was the main agent for adhesive composition (product name “SK Dine 2147”, made by Soken Kakagu Corp), 0.05 weight part of curing agent (product name “TD-75” made by Soken Kakagu Corp), 0.05 weight part of coupling agent (Product name “A-50” made by Soken Kagaku Corp), and 0.5 weight part of antistatic agent lithiumbis (trifluoro sulfonyl) imide (LiTFSI, made by Wako Chemical Corp) were mixed and a resin solution was obtained.

Resin solution obtained was coated on peelable sheet with 170 μm thickness (sheet with silicone peeling processing applied on one surface of polyethylene terephthalate (PET)), dried for 3 minutes at 90° C., then it was pasted to one surface of the polarizing plate described above, and furthermore, it was left for three days under 25° C. and relative humidity 60% environment to age, thus adhesive layer A was made on one side of polarizing plate.

The structure of the antistatic agent used above is shown below.

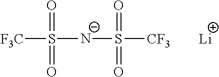 [SMILES: O=S(=O)([N-]S(=O)(=O)C(F)(F)F)C(F)(F)F ; [Li+]]

6. Preparation of Antistatic Agent-Containing Adhesive Layer B

The amount of antistatic agent lithiumbis (trifluoro sulfonyl) imide (LiTFSI, made by Wako Chemical Corp) added was changed to 0. 3 weight part, other than that, doing same as the adhesive layer A, adhesive layer B was made.

7. Preparation of Adhesive Layer C Containing Antistatic Agent and Amine Compound

100 weight parts of acrylic resin solution which was the main agent for adhesive composition (product name “SK Dine 2147” made by Soken Kakagu Corp), 0.05 weight part of curing agent (product name “TD-75” made by Soken Kakagu Corp), 0.05 weight part of coupling agent (product name “A-50” made by Soken Kagaku Corp), and 0.5 weight part of antistatic agent lithiumbis (trifluoro sulfonyl) imide (LiTFSI, made by Wako Chemical Corp) were mixed, furthermore by adding 0.1 weight part of amine A2, the resin solution was obtained.

Resin solution obtained was coated on peelable sheet with 170 μm thickness (sheet with silicone peeling processing applied on one surface of PET), dried for 3 minutes at 90° C., then it was pasted to one surface of the polarizing plate described above, and furthermore, it was left for three days under 25° C. and relative humidity 60% environment to age, thus adhesive layer C was made on one side of polarizing plate.

Preparation methods of polarizing plates of Examples and Comparative Examples having adhesive layers A to C are as described above.

8. Preparation of antistatic layer D using sulfonyl group-containing conductive polymer and adhesive layer “a” containing no antistatic agent.

On the surface on the cell side of cellulose acylate film, 2.8 weight percent aqueous solution of poly(3,4-ethylene dioxythiophene)/polystyrene sulfonic acid complex (PEDOT/PSS) (made by Aldrich Corp) was coated, and dried for 2 minutes by 80° C. warm wind dryer and antistatic layer D (thickness 0.5 μm) was formed.

On the other hand, 100 weight parts of the main agent for adhesive composition, acrylic resin solution (product name “SK Dine 2147” made by Soken Kagaku Corp), 0.05 weight part pf curing agent (product name “TD-75” made by Soken Kagaku Corp), and 0.05 weight part of coupling agent (product name “A-50” made by Soken Kagaku Corp) were mixed to obtain a resin solution.

Resin solution thus obtained were coated on peelable sheet (sheet with silicone peeling processing applied on one surface of PET) with 170 μm thickness, dried for 3 minutes at 90° C., thus adhesive layer a was obtained. Furthermore, adhesive layer a was laminated on antistatic layer D and furthermore, in the environment of 25° C. and relative humidity 60 percent, left for three days to age, thereby a laminated body was obtained in which on one surface of cellulose acylate film, antistatic layer D and adhesive layer “a” described above were laminated in this order.

9. Preparation of Antistatic Layer E Using Sulfonyl Group-Containing Conductive Polymer and the Above Adhesive Layer “a”

Polystyrene sulfonic acid aqueous solution was used in antistatic layer, other than that, doing the same as in the above 8, on one surface of cellulose acylate film, antistatic layer E and adhesive layer “a” described above were laminated in this order.

10. Preparation of Viewing Side Peelable Film (DE1) Having Adhesive Layer F Containing Antistatic Agent

### <Adhesive Composition (S)>

Into a 4 neck flask equipped with stirring blades, a thermometer, a nitrogen gas guide pipe, a cooler and a dropping funnel, 200 weight parts of 2-ethyl hexyl acrylate (2EHA), 8 weight parts of 2-hydroxy ethyl acrylate (HEA), 0.4 weight part of azobis isobutyl nitrile (AIBN), and 312 weight parts of ethyl acetate were added, and while stifling mildly, nitrogen gas was introduced and while keeping solution temperature in flask near 65° C., polymerization reaction was performed for 6 hours, thereby acrylic polymer (P1) solution with 40 weight percent of solid component concentration was prepared. To solution 100 weight parts (contain 20 weight parts of acrylic polymer (P1)) that was diluted into 20 weight percent of solid component concentration by adding ethyl acetate into acrylic polymer (P1) solution described above, the following was added: 0.8 weight part of antistatic agent lithiumbis (trifluoro sulfonyl) imide (LiTFSI, made by Wako Chemical Corp), 0.3 weight part of isocyanurate body of hexamethylene diisocyanate (made by Nihon Polyurethane Ind. Corp, product name “Coronate HX”), 0.4 weight part of dibutyltin dilaurate as cross linking catalyst (1 weight percent ethyl acetate solution). Then, the mixture was stirred and mixed about 1 minute at 25° C. Doing like this, acrylic adhesive composition (S) that contained 4 weight parts of antistatic agent per 100 weight parts of acrylic polymer (P1) was prepared.

### <Preparation of Viewing Side Peelable Film DE1>

On the corona-treated surface of transparent polyetheylene terephthalate (PET) with thickness 38 μm with corona treatment provided on one surface (first surface), adhesive composition (S) was coated, and it was heated for 2 minutes at 130° C., and dried to form adhesive layer F with thickness 15 μm. On the adhesive layer F was pasted peeling-treated surface of PET film (peeling liner) of thickness 25 μm in which on one surface was provided peeling treatment by silicone peeling treatment agent, and peelable film DE1 was made.

11. Preparation of Viewing Side Peelable Film (DE2) Having Adhesive Layer “b” Containing No Antistatic Agent

Lithiumbis (trifluoro sulfonyl) imide (LiTFSI, made by Wako Chemical Corp) was not added to adhesive composition (S), other than that, doing the same as 10. described above, viewing side peelable film (DE2) having adhesive layer “b” containing no antistatic agent was made.

Using the combination as described in Table 5 described below, the polarizing plates of Examples and Comparative Examples were obtained in which on the pasting side with the cell of the polarizing plate, the adhesive layer (adhesive layers A to C, or laminated body of antistatic layer D or E and adhesive “a”) was formed and on the other surface was pasted peelable film (DE1 or DE2).

Regarding the polarizing plate of Reference Example, adhesive layer A was changed to adhesive layer “a” containing no antistatic agent, other than that, it was made the same as in Comparative Example 1.

After making it each polarizing plate was left for two weeks under 25° C. and relative humidity 60 percent and the following evaluations were made. Among the following evaluations, except for display failure evaluation, the evaluation was performed after peeling peelable film (DE1 to DE2).

12. Evaluation Method

### (1) Surface Resistance (Antistatic Effect) Evaluation

If the evaluation result of surface resistance based on the evaluation standard described below is 2 or 3, when a polarizing plate is pasted to a liquid crystal cell, the failure occurrence of liquid crystal display panel by static electricity generated as polarizing plate protective film is peeled from the polarizing plate is greatly reduced. Regarding Examples 1 to 14, 16 to 19, and Comparative Examples 1 to 9, the surface resistance of the adhesive layer on the surface pasted to a liquid crystal cell side of the polarizing plate was measured, and regarding Example 15 and Comparative Example 10, the surface resistance of peelable film was measured and shown in the Table.

### [Evaluation Standard]

3: Surface resistance <10×10¹²Ω/□
2: 10×10¹²Ω/□≦surface resistance <10×10¹³Ω/□
1: 10×10¹³Ω/□<surface resistance

### [Measurement Method]

After samples were placed for 2 hours under the condition of 25° C. and relative humidity 60%, resistivity cell (made by Agilent Technology Corp, Agilent 16008B) was connected to a high resistance meter (made by Agilent Technology Corp, Agilent 4339B), the surface resistance was measured under the conditions of temperature 25° C. and relative humidity 60%.

### (2) Amount of Change in 410 Nm Orthogonal Transmissivity by 1,000 Hour Storage Under 60° C. and Relative Humidity 90%

[Evaluation standard]
3: equal to or less than 0.4%
2: higher than 0.4% and equal to or less than 0.7%
1: higher than 0.7%

### [Measurement Method]

Orthogonal transmissivity was measured using an automatic polarizing film measurement device VAP-7070 made by Nihon Bunkou Corp. The measurement was done at wavelength 410 nm.

In general, orthogonal transmissivity can be measured by the following two types of measurement methods:

(A) Using two sheets of polarizing plates, a measurement method of measuring by orthogonally positioning absorption axis of a polarizer,
(B) Using one sheet of a polarizing plate, a measurement method of measuring by orthogonally positioning the absorption axis of Glan-Taylor prism attached to the device and polarizer absorption axis of one sheet of polarizing plate.

Here, among the measurement methods of (A) and (B) described above, (B) measurement method was adopted. Orthogonal transmissivity measurement by (B) measurement method was done as follows. Two samples (5 cm×5 cm) were pasted on a glass so that polarizing plate was placed on a glass so that the film on a liquid crystal cell side in Table 5 was on glass side.

Orthogonal transmissivity was measured by setting up the glass side of the sample to be directed toward light source. Each of two samples was measured and the average value was orthogonal transmissivity.

Regarding each sample, orthogonal transmissivity before the storage was the measurement value after the sample was left for 24 hours in the environment of 25° C. and relative humidity 60%. After that, after storing for 1,000 hours in the environment of 60° C. and relative humidity 90%, furthermore, the measurement value after leaving for 24 hours in the environment of 25° C. and relative humidity 60%, furthermore set to be the orthogonal transmissivity after storage.

Using (orthogonal transmissivity after storage—orthogonal transmissivity before storage), the amount of change in orthogonal transmissivity by storage was calculated.

If the evaluation result by the evaluation standard described above is 2 or 3, the product can be used at the level that does not pose any issue in practical use.

(3) Amount of increase in haze of polarizing plate after storing 1,000 hours at 60° C. and relative humidity 90%

### [Evaluation Standard]

3: less than 0.5, 2: 0.5 to 1.0, 1: higher than 1.0

### [Measurement Method]

Regarding each polarizing plate, after and before storing for 1,000 hours in the environment of 60° C. and relative humidity 90%, the entire haze was measured; using (entire haze after storage—entire haze before storage), the amount of increase in haze was calculated. To measure the entire haze, while polarizing plate sample was pasted on a glass via adhesive, the measurement was done according to JIS K-6714 using a haze meter HGM-2DP (made by Suga test machine Corp) under the conditions of 25° C. and relative humidity 60%.

If the evaluation result by the evaluation standard described above is 2 or 3, the product can be used at the level that does not pose any issue in practical use.

### (4) Existence or Non-Existence of Display Failure

A liquid crystal Television (TV) made by SAMSUNG Corp. (UN40EH6030F) was taken apart, and a polarizing plate was peeled to obtain a liquid crystal cell. Each polarizing plate prepared was pasted to the viewing side of the liquid crystal cell. Pasted surface of the liquid crystal panel was placed on backlight facing upward. Next, peelable film of polarizing plate was peeled in 180° direction at the fixed speed of 5 m/minute to observe liquid crystal layer disruption. The evaluation was done by the following standard. If the evaluation result by the evaluation standard described below is 2 or 3, the product can be used at the level that does not pose any issue in practical use.

### [Evaluation Standard and the Like]

3: There is no display disruption or it is so small that it does not harm the practical use.
2: There is display disruption, but the condition returns to original state within a minute
1: Display disruption is large and it takes equal to or more than 1 minute before the condition returns to the original state

The results are shown in Table 5.

TABLE 5

| | Position of Film | | | | | After storage at | | |
|---|---|---|---|---|---|---|---|---|
| | Display | Liquid | | | | 60° C. 90%, 1000 h | | |
| | surface | crystal | Adhesive layer | Peelable Film | Surface | Transmis- | | Display |
| | side | cell side | (liquid crystal cell side) | (viewing side) | resistance | sivity | Δhaze | failure |
| Comp. | Film 1 | Film 1 | Adhesive layer A | DE2 | 3 | 1 | 1 | 3 |
| Ex. 1 | | | (Sulfonyl group-containing | | | | | |
| | | | compound was contained.) | | | | | |
| Comp. | Film 1 | Film 1 | Adhesive layer B | DE2 | 2 | 1 | 1 | 2 |
| Ex. 2 | | | (Sulfonyl group-containing | | | | | |
| | | | compound was contained.) | | | | | |
| Comp. | Film 1 | Film 6 | Adhesive layer A | DE2 | 3 | 1 | 2 | 3 |
| Ex. 3 | | | (Sulfonyl group-containing | | | | | |
| | | | compound was contained.) | | | | | |
| Ex. 1 | Film 1 | Film 7* | Adhesive layer A | DE2 | 3 | 2 | 3 | 3 |
| | | | (Sulfonyl group-containing | | | | | |
| | | | compound was contained.) | | | | | |
| Ex. 2 | Film 2 | Film 8* | Adhesive layer A | DE2 | 3 | 2 | 2 | 3 |
| | | | (Sulfonyl group-containing | | | | | |
| | | | compound was contained.) | | | | | |
| Ex. 3 | Film 2 | Film 9* | Adhesive layer A | DE2 | 3 | 3 | 2 | 3 |
| | | | (Sulfonyl group-containing | | | | | |
| | | | compound was contained.) | | | | | |
| Ex. 4 | Film 3 | Film 10* | Adhesive layer A | DE2 | 3 | 3 | 3 | 3 |
| | | | (Sulfonyl group-containing | | | | | |
| | | | compound was contained.) | | | | | |
| Ex. 5 | Film 4 | Film 11* | Adhesive layer A | DE2 | 3 | 3 | 2 | 3 |
| | | | (Sulfonyl group-containing | | | | | |
| | | | compound was contained.) | | | | | |
| Ex. 6 | Film 5 | Film 12* | Adhesive layer A | DE2 | 3 | 3 | 3 | 3 |
| | | | (Sulfonyl group-containing | | | | | |
| | | | compound was contained.) | | | | | |
| Comp. | Film 2 | Film 13 | Adhesive layer A | DE2 | 3 | 1 | 1 | 3 |
| Ex. 4 | | | (Sulfonyl group-containing | | | | | |
| | | | compound was contained.) | | | | | |
| Comp. | Film 3 | Film 13 | Adhesive layer A | DE2 | 3 | 1 | 1 | 3 |
| Ex. 5 | | | (Sulfonyl group-containing | | | | | |
| | | | compound was contained.) | | | | | |
| Comp. | Film 4 | Film 14 | Adhesive layer A | DE2 | 3 | 1 | 1 | 3 |
| Ex. 6 | | | (Sulfonyl group-containing | | | | | |
| | | | compound was contained.) | | | | | |
| Comp. | Film 5 | Film 14 | Adhesive layer A | DE2 | 3 | 1 | 1 | 3 |
| Ex. 7 | | | (Sulfonyl group-containing | | | | | |
| | | | compound was contained.) | | | | | |
| Ex. 7 | Film 2 | Film 13 | Adhesive layer C | DE2 | 3 | 3 | 3 | 3 |
| | | | (Sulfonyl group-containing | | | | | |
| | | | compound and aromatic | | | | | |
| | | | secondary amine | | | | | |
| | | | were contained.) | | | | | |
| Comp. | Film 3 | Film 13 | Laminated body of sulfonyl | DE2 | 3 | 1 | 1 | 3 |
| Ex. 8 | | | group-containing | | | | | |
| | | | conductive polymer | | | | | |
| | | | layer D + Adhesive layer a | | | | | |
| Comp. | Film 4 | Film 14 | Laminated body of sulfonyl | DE2 | 3 | 1 | 1 | 3 |
| Ex. 9 | | | group-containing | | | | | |
| | | | conductive polymer | | | | | |
| | | | layer E + Adhesive layer a | | | | | |
| Ex. 8 | Film 1 | Film 15* | Adhesive layer A | DE2 | 3 | 3 | 3 | 3 |
| | | | (Sulfonyl group-containing | | | | | |
| | | | compound was contained.) | | | | | |
| Ex. 9 | Film 2 | Film 16* | Adhesive layer A | DE2 | 3 | 3 | 3 | 3 |
| | | | (Sulfonyl group-containing | | | | | |
| | | | compound was contained.) | | | | | |
| Ex. 10 | Film 3 | Film 16* | Adhesive layer A | DE2 | 3 | 3 | 3 | 3 |
| | | | (Sulfonyl group-containing | | | | | |
| | | | compound was contained.) | | | | | |
| Ex. 11 | Film 3 | Film 16* | Laminated body of sulfonyl | DE2 | 3 | 3 | 3 | 3 |
| | | | group-containing | | | | | |
| | | | conductive polymer | | | | | |
| | | | layer D + Adhesive layer a | | | | | |
| Ex. 12 | Film 3 | Film 16* | Laminated body of sulfonyl | DE2 | 3 | 3 | 3 | 3 |
| | | | group-containing | | | | | |
| | | | conductive polymer layer | | | | | |
| | | | E + Adhesive layer a | | | | | |
| Ex. 13 | Film 4 | Film 17* | Adhesive layer A | DE2 | 3 | 2 | 2 | 3 |
| | | | (Sulfonyl group-containing | | | | | |
| | | | compound was contained.) | | | | | |
| Ex. 14 | Film 5 | Film 17* | Adhesive layer A | DE2 | 3 | 2 | 2 | 3 |
| | | | (Sulfonyl group-containing | | | | | |
| | | | compound was contained.) | | | | | |
| Ex. 15 | Film 7* | Film 13 | Adhesive layer a | DE1 | 3 | 3 | 3 | 3 |
| | | | | (Adhesive composition | | | | |
| | | | | S, in which sulfonyl | | | | |
| | | | | group-containing | | | | |
| | | | | compound was contained, | | | | |
| | | | | was contained.) | | | | |
| Comp. | Film 1 | Film 13 | Adhesive layer a | DE1 | 3 | 2 | 1 | 3 |
| Ex. 10 | | | | (Adhesive composition | | | | |
| | | | | S, in which sulfonyl | | | | |
| | | | | group-containing | | | | |
| | | | | compound was contained, | | | | |
| | | | | was contained.) | | | | |
| Ex. 16 | Film 3 | Film 18 | Adhesive layer A | DE2 | 3 | 2 | 2 | 3 |
| | | | (Sulfonyl group-containing | | | | | |
| | | | compound was contained.) | | | | | |
| Ex. 17 | Film 3 | Film 19 | Adhesive layer A | DE2 | 3 | 3 | 3 | 3 |
| | | | (Sulfonyl group-containing | | | | | |
| | | | compound was contained.) | | | | | |
| Ex. 18 | Film 4 | Film 20 | Adhesive layer A | DE2 | 3 | 3 | 3 | 3 |
| | | | (Sulfonyl group-containing | | | | | |
| | | | compound was contained.) | | | | | |
| Ex. 19 | Film 4 | Film 21 | Adhesive layer A | DE2 | 3 | 3 | 3 | 3 |
| | | | (Sulfonyl group-containing | | | | | |
| | | | compound was contained.) | | | | | |
| Ref. Ex. | Film 1 | Film 1 | Adhesive layer a | DE2 | 1 | 3 | 3 | 1 |

*Film containing aromatic secondary amine

Evaluation Result

From the comparison of Reference Examples and Examples, Comparative Examples shown in Table 5, regarding the polarizing plate having an antistatic layer that contains a sulfonyl group-containing compound, reduction of surface resistance can be confirmed. Moreover, it can be understood that this can prevent the display failure of the liquid crystal display device from occurring.

However, regarding the polarizing plates of Comparative Examples in which the antistatic layer described above was provided, but any film or layer containing aromatic secondary amine wasn't provided, transmissivity reduction and haze increase after storing in high temperature and high humidity were confirmed.

By contract, regarding polarizing plates of Examples, transmissivity reduction after storing in high temperature and high humidity was low, and there was no large rise in haze, so it can be understood that quality reduction over time can be inhibited by providing a film or layer containing aromatic secondary amine. Moreover, by comparing Examples, it can be confirmed that the effect described above was marked in Examples that used amine A2, A3, A5 containing a heteroaromatic ring as aromatic secondary amine.

From the above result, it was verified that, according to an aspect of the present invention, a liquid crystal display device could be be provided that was superior in display performance and was low in deterioration of polarizing plates over time.

### DESCRIPTION OF SYMBOLS IN DRAWINGS

10, 20 polarizing plate
11, 21 polarizer
12a, 12b, 22a, 22b polymer film
23 antistatic layer
14a, 14b, 24a, 24b adhesive layer
15a, 15b, 25a, 25b peelable film

Although the present invention has been described in considerable detail with regard to certain versions thereof, other versions are possible, and alterations, permutations and equivalents of the version shown will become apparent to those skilled in the art upon a reading of the specification and study of the drawings. Also, the various features of the versions herein can be combined in various ways to provide additional versions of the present invention.

Furthermore, certain terminology has been used for the purposes of descriptive clarity, and not to limit the present invention. Therefore, any appended claims should not be limited to the description of the preferred versions contained herein and should include all such alterations, permutations, and equivalents as fall within the true spirit and scope of the present invention.

Having now fully described this invention, it will be understood to those of ordinary skill in the art that the methods of the present invention can be carried out with a wide and equivalent range of conditions, formulations, and other parameters without departing from the scope of the invention or any Examples thereof.

All patents and publications cited herein are hereby fully incorporated by reference in their entirety. The citation of any publication is for its disclosure prior to the filing date and should not be construed as an admission that such publication is prior art or that the present invention is not entitled to antedate such publication by virtue of prior invention.

What is claimed is:

1. A laminated body, which is a laminated body for a polarizing plate as well as comprises a polymer film and a layer comprising a sulfonyl group-containing compound, wherein either or both of the polymer film and the layer comprising a sulfonyl group-containing compound comprises an aromatic secondary amine.

2. The laminated body according to claim 1, wherein the aromatic secondary amine comprises a heteroaromatic ring.

3. The laminated body according to claim 1, wherein the sulfonyl group-containing compound is a metal salt of sulfonyl imide anion and metal cation.

4. The laminated body according to claim 2, wherein the sulfonyl group-containing compound is a metal salt of sulfonyl imide anion and metal cation.

5. The laminated body according to claim 1, wherein the sulfonyl group-containing compound is a metal salt of fluorosulfonylimide anion and metal cation.

6. The laminated body according to claim 2, wherein the sulfonyl group-containing compound is a metal salt of fluorosulfonylimide anion and metal cation.

7. The laminated body according to claim 1, wherein the sulfonyl group-containing compound is a metal salt of sulfonyl imide anion and alkaline metal cation.

8. The laminated body according to claim 2, wherein the sulfonyl group-containing compound is a metal salt of sulfonyl imide anion and alkaline metal cation.

9. The laminated body according to claim 1, wherein the sulfonyl group-containing compound is a compound comprising a sulfonyl group in the form of a sulfo group or a salt thereof.

10. The laminated body according to claim 9, wherein the sulfonyl group-containing compound is a polymer of styrene sulfonic acid or a salt thereof.

11. The laminated body according to claim 2, wherein the sulfonyl group-containing compound is a compound comprising a sulfonyl group in the form of a sulfo group or a salt thereof.

12. The laminated body according to claim 11, wherein the sulfonyl group-containing compound is a polymer of styrene sulfonic acid or a salt thereof.

13. The laminated body according to claim 1, wherein the layer comprising a sulfonyl group-containing compound is an adhesive layer or an intermediate layer positioned between an adhesive layer and the polymer film.

14. The laminated body according to claim 13, wherein the adhesive layer comprises acrylic adhesive.

15. The laminated body according to claim 1, wherein the polymer film is a cellulose acylate film.

16. The laminated body according to claim 2, wherein the polymer film is a cellulose acylate film.

17. The laminated body according to claim 1, which comprises the layer comprising a sulfonyl group-containing compound as a layer that directly contacts the polymer film.

18. The laminated body according to claim 2, which comprises the layer comprising a sulfonyl group-containing compound as a layer that directly contacts the polymer film.

19. A polarizing plate, which comprises the laminated body according to claim 1 and a polarizer.

20. A liquid crystal display device, which comprises the polarizing plate according to claim 19 and a liquid crystal cell.
